(19) United States
(12) Patent Application Publication
(10) Pub. No.: US 2013/0159181 A1
(43) Pub. Date: Jun. 20, 2013

(54) System and Method for Enhanced Mobile Wallet

(71) Applicant: Sybase 365, Inc., Reston, VA (US)

(72) Inventor: Markus Hueck, Bonn (DE)

(73) Assignee: SYBASE 365, INC., Reston, VA (US)

(21) Appl. No.: 13/721,165

(22) Filed: Dec. 20, 2012

Related U.S. Application Data
(60) Provisional application No. 61/577,744, filed on Dec. 20, 2011.

(51) Int. Cl. G06Q 20/36

(52) U.S. Cl. CPC G06Q 20/36
USPC 705/41

(57) ABSTRACT

A flexible, extensible, and dynamically configurable Mobile Wallet (mWallet) facility that inter alia leverages the ubiquitous nature of wireless devices to inter alia ‘store’ a quanta of value (including inter alia an amount of money, coupons, vouchers, credits, points, rewards/awards, etc.) on a wireless device so that a user of such a device may subsequently employ just their ever-present wireless device to among other things complete the payment portion of a transaction.

This application claims the benefit of U.S. Provisional Patent Application Ser. No. 61/577,744, filed on 20 Dec. 2011, which is incorporated herein in its entirety.

### BACKGROUND

1. Field of the Invention

The present invention relates generally to payment mechanisms. More particularly, the present invention relates to capabilities that enhance substantially the value, usefulness, etc. of a Wireless Device (WD) when the WD is used to make, facilitate, etc. a payment within for example the world of commerce.

2. Background of the Invention

As the ‘wireless revolution’ continues to march forward through various flavors of 2G, 3G, 4G, and beyond, the importance to a Mobile Subscriber (MS)—for example a user of a WD that is serviced by possibly inter alia a Wireless Carrier (WC)—of their WD grows substantially. Examples of WDs include, possibly inter alia, mobile telephones, handheld computers, Internet-enabled phones, pagers, radios, TVs, audio devices, car audio (and other) systems, recorders, text-to-speech devices, bar-code scanners, net appliances, mini-browsers, Personal Data Assistants (PDAs), etc.

For example, the wireless telecommunications industry trade group CTIA—The Wireless Association, forecasts that in mid-2011 there were approximately 323 m MSs in the U.S., up from approximately 220 m MSs in the U.S. in mid-2006.

One consequence of such a growing importance to a MS of their WD is the resulting ubiquitous nature of WDs—i.e., MSs carry them at almost all times and use them for an ever-increasing range of activities. For example, MSs employ their WDs to, possibly inter alia:

1) Exchange messages with other MSs (e.g., “Let's meet for dinner at 6”) through Peer-to-Peer, or P2P, messaging.

2) Secure information (such as, for example, weather updates, travel alerts, news updates, sports scores, etc.), participate in voting initiatives (such as, for example, with the television show American Idol®), interact with social networking sites, etc. through various of the available Application-to-Peer, or A2P, based service offerings.

3) Engage in Mobile Commerce (mCommerce, which broadly speaking, encompasses the buying and selling of merchant-supplied products, goods, and services through a WD) and Mobile Banking (mBanking, which, broadly speaking, encompasses performing various banking activities through a WD).

Credit cards, debit cards, pre-paid credit/debit cards, stored value cards, etc. have traditionally been used to complete the payment portion of a transaction (e.g., the purchase of an item at a store, from a vending machine, etc.).

However, not every MS necessarily has such an artifact or is able, willing, etc. to use such an artifact in connection with making a payment.

Additionally, some MSs have concerns about providing credit card, debit card, etc. information to complete the payment portion of a transaction. Such concerns may be related to inter alia the potential for fraud or identity theft, the cost of using such a device, the inconvenience or the complexity of using such a device, etc.

What is needed is a flexible, extensible, dynamically configurable, etc. Mobile Wallet (mWallet) mechanism that inter alia leverages the ubiquitous nature of WDs to inter alia ‘store’ a quanta of value (including inter alia an amount of money, coupons, vouchers, credits, points, rewards/awards, etc.) on a WD so that a MS may subsequently employ just their ever-present WD to among other things complete the payment portion of a transaction.

Aspects of the present invention fills the lacuna that was noted above by (1) providing an enhanced mWallet mechanism while (2) addressing, in new and innovatory ways, various of the not insubstantial challenges that are associated with same.

### SUMMARY OF THE INVENTION

In one embodiment of the present invention there is provided a computing device-based method for implementing a mWallet facility that includes at least (a) receiving a unique identifier that is associated with the mWallet, (b) using the unique identifier to ascertain information about the mWallet including at least a quanta of value that was previously added to the mWallet, and (c) sending aspects of the ascertained information.

Further features and advantages of the present invention, as well as the structure and operation of various embodiments thereof, are described in detail below with reference to the accompanying drawings. It should be noted that the invention is not limited to the specific embodiments described herein. Such embodiments are presented herein for illustrative purposes only. Additional embodiments will be readily apparent to persons skilled in the relevant arts based on the teachings contained herein

### BRIEF DESCRIPTION OF THE DRAWINGS

The accompanying drawings, which are incorporated herein and form part of the specification, depict embodiments of the present invention and, together with the summary that was presented above and the description that may be found below, further serve to illustrate inter alia the principles, structure, and operation of such embodiments. It will be readily apparent to one of ordinary skill in the relevant art that numerous variations, modifications, alternative forms, etc. of the depicted embodiments are easily possible and indeed are within the scope of the present invention.

FIG. 1 is a diagrammatic presentation of an exemplary Messaging Inter-Carrier Vendor (MICV).

FIG. 2 illustrates one particular arrangement that is possible through aspects of the present invention.

FIG. 3 illustrates various of the exchanges or interactions that are possible during an optional registration portion of the present invention.

FIG. 4 illustrates various of the exchanges or interactions that are possible under aspects of the present invention when a MS adds a quanta of value to a mWallet.

FIG. 5 illustrates various of the exchanges or interactions that are possible under aspects of the present invention when a MS employs a mWallet.

FIG. 6 illustrates various implementation aspects of an exemplary Service Provider (SP).

FIG. 7 illustrates various implementation aspects of an exemplary SP Data Processing Engine (DPE).

FIG. 8 depicts aspects of a hypothetical WorkFlow implementation that is possible under aspects of the present invention.

FIG. 9 depicts an exemplary computer system through which embodiments of aspects of the present invention may be implemented.

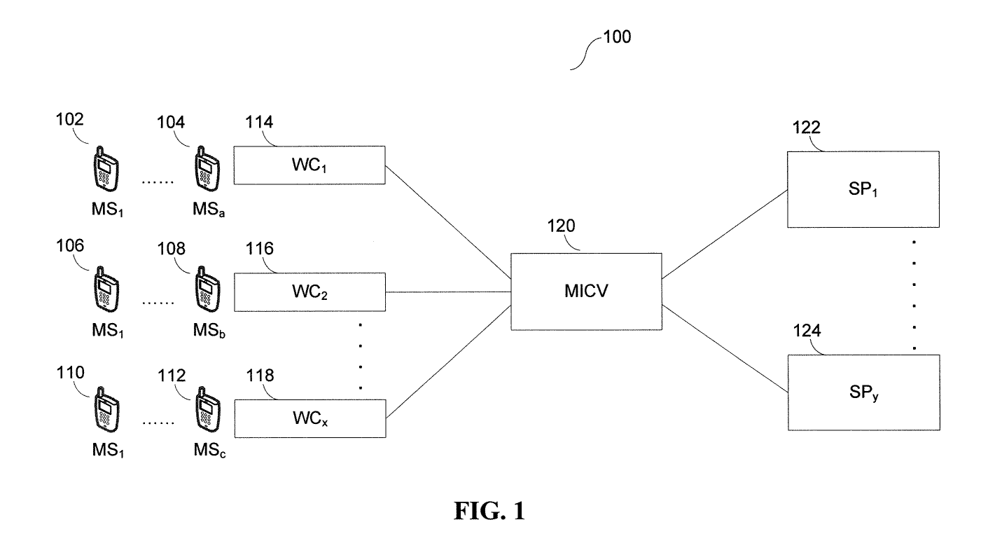

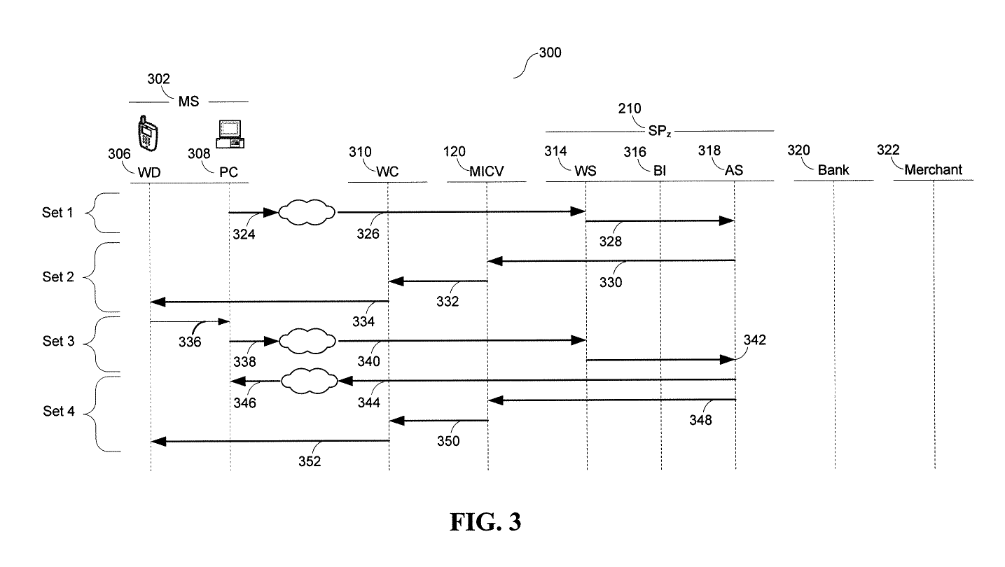

The present invention will now be described with reference to the accompanying drawings. In the drawings, generally, like reference numbers indicate identical or functionally similar elements. Additionally, generally, the left-most digit(s) of a reference number identifies the drawing in which the reference number first appears. For example, in FIG. 3 the reference numeral 120 would direct the reader to FIG. 1 for the first appearance of that reference numeral.

### DETAILED DESCRIPTION OF THE INVENTION

The following detailed description of the present invention refers to the accompanying drawings that illustrate exemplary embodiments consistent with this invention. Other embodiments are possible, and modifications can be made to the embodiments within the spirit and scope of the invention. Therefore, the detailed description is not meant to limit the invention.

Note that in this description references to “one embodiment” or “an embodiment” mean that the feature being referred to is included in at least one embodiment of the present invention. Further, separate references to “one embodiment” in this description do not necessarily refer to the same embodiment; however, neither are such embodiments mutually exclusive, unless so stated and except as will be readily apparent to those skilled in the art.

In the discussion below aspects of the present invention are described and illustrated as leveraging a centrally-located, full-featured MICV facility. Reference is made to U.S. Pat. No. 7,154,901 entitled “INTERMEDIARY NETWORK SYSTEM AND METHOD FOR FACILITATING MESSAGE EXCHANGE BETWEEN WIRELESS NETWORKS,” and its associated continuations, for a discussion of the concept of a MICV, a summary of various of the services/functions/etc. that may be performed by a MICV, and a discussion of various of the advantages that may arise from same.

A MICV may, for example, be realized through any combination of, possibly inter alia, any one or more of (1) an element of a WC, an element of a landline carrier, or multiple such elements working together; (2) a Third-Party (3P) such as possibly inter alia a merchant, a Content Provider (CP, such as for example a news organization, an advertising agency, a brand, etc.), a financial institution, a SP (such as for example a hosting firm, etc.), etc.; (3) multiple 3P entities working together; (4) a service bureau; (5) a message service provider, and/or (6) other entities.

To provide some context for the particulars of the present invention consider for a moment the exemplary MICV 120 that is depicted (albeit only partially, at a high-level, and from a logical perspective) in FIG. 1 and reference numeral 100. The illustrated MICV 120 is disposed between, possibly inter alia, multiple WCs (WC₁ 114, WC₂ 116, →WCₓ 118) on one side and multiple SPs (SP₁122→SP_{y} 124) on the other side and is, in effect, a horizontally and vertically scalable ‘hub’ that may among other things ‘bridge’ all of the connected entities and inter alia facilitate the ubiquitous exchange of information (including, inter alia, data, Short Message Service (SMS) messages, Multimedia Message Service (MMS) messages, data, etc.) between various of the connected participants. A MICV 120 thus, as one simple example, may offer various routing, formatting, delivery, value-add, etc. capabilities that provide, possibly inter alia:

1) A WC WC₁ 114→WCₓ 118 (and, by extension, all of the MSs (MS₁ 102→MSₐ 104, MS₁ 106→MS_{b} 108, MS₁ 110→MS_{c} 112) that are serviced by the WC WC₁ 114→WCₓ 118) with ubiquitous access to a broad universe of SPs SP₁ 122→SP_{y} 124, and

2) A SP SP₁ 122→SP_{y} 124 with ubiquitous access to a broad universe of WCs WC₁ 114→WCₓ 118 (and, by extension, to all of the MSs (MS₁ 102→MSₐ 104, MS₁ 106→MS_{b} 108, MS₁ 110→MS_{c} 112) that are serviced by the WCs WC₁ 114→WCₓ 118).

Generally speaking a MICV may have varying degrees of visibility (e.g., access, etc.) to the (MS←→MS, MS←→SP, etc.) data exchange. For example, within a messaging context:

1) A WC may elect to route just their out-of-network messaging traffic to a MICV. Under this approach the MICV would have visibility (e.g., access, etc.) to just the portion of the WC's messaging traffic that was directed to the MICV by the WC.

2) A WC may elect to route all of their messaging traffic to a MICV. The

MICV may, possibly among other things, subsequently return to the WC that portion of the messaging traffic that belongs to (i.e., that is destined for a MS of) the WC. Under this approach the MICV would have visibility (e.g., access, etc.) to all of the WC's messaging traffic.

While the discussion below will include a MICV, it will be readily apparent to one of ordinary skill in the relevant art that numerous other arrangements are equally applicable and indeed are fully within the scope of the present invention.

As just one example of an alternative arrangement, aspects of the present invention may be offered by a SP. A SP may, for example, be realized through any combination of, possibly inter alia, any one or more of (1) an element of a WC, an element of a landline carrier, an element of a MICV, or multiple such elements working together; (2) a 3P such as possibly inter alia a merchant, a CP (such as for example a news organization, an advertising agency, a brand, etc.), a financial institution, etc.; (3) multiple 3P entities working together; (4) a service bureau; (5) a message service provider; and/or (6) other entities.

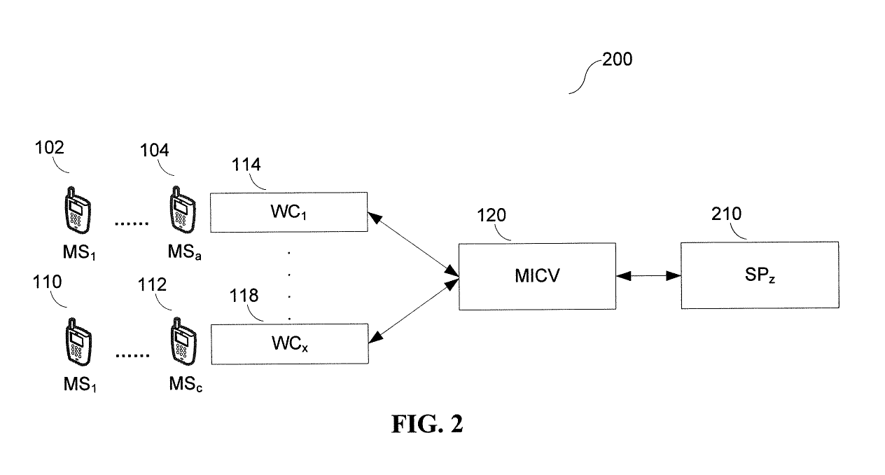

FIG. 2 and reference numeral 200 depict one particular approach that may be possible under such an alternative arrangement. As the diagram portrays, the messaging traffic of numerous MSs (MS₁ 102→MSₐ 104 and MS₁ 110→MS_{c} 112) that are serviced by WC₁ 114→WCₓ 118 is exchanged with a MICV 120 and the MICV 120 is connected with SP_{z} 210 (a SP that offers, possibly inter alia, aspects of the present invention).

While the paragraph above referred to one specific alternative arrangement, it will be readily apparent to one of ordinary skill in the relevant art that numerous other alternative arrangements (including inter alia the use of multiple SPs; the sharing, blending, etc. of functionality between a MICV and one or more SPs; etc.) are equally applicable and indeed are fully within the scope of the present invention.

For variety, completeness etc. of exposition, portions of the discussion below will include a MICV and a SP. As noted above, it will be readily apparent to one of ordinary skill in the relevant art that numerous other arrangements are easily possible (e.g., any combination of one or more of inter alia a single MICV, multiple MICVs, a single SP, multiple SPs, etc.).

In the discussion below reference is made to messages that may be sent, for example, between a MS and a SP. As set forth below, a given ‘message’ sent between a MS and a SP may actually comprise a series of steps in which the message is received, forwarded and routed between different entities, including possibly inter alia a MS, a WC, a MICV, and a SP. Thus, unless otherwise indicated, it will be understood that reference to a particular message generally includes that particular message as conveyed at any stage between an origination source, such as for example a MS, and an end receiver, such as for example a SP. As such, reference to a particular message generally includes a series of related communications between, for example, a MS and a WC; a WC and a MICV; a MICV and a SP; etc. The series of related communications may, in general, contain substantially the same information, or information may be added or subtracted in different communications that nevertheless may be generally referred to as a same message. To aid in clarity, a particular message, whether undergoing changes or not, is referred to by different reference numbers at different stages between a source and an endpoint of the message.

To better understand the particulars of the present invention consider for a moment a simple hypothetical example—a SP, SP_{z}, offers a service that has been enhanced or augmented as provided through aspects of the instant invention and Mary, a MS, uses SP_{z}'s service.

As noted above, FIG. 2 and reference numeral 200 depict one particular arrangement that may be possible under our hypothetical example.

FIG. 3 and reference numeral 300 illustrate various of the exchanges or interactions that might occur under an optional registration portion of our hypothetical example. A registration process may be tailored (e.g., the range of information gathered; the scope of access, permissions, capabilities, etc. subsequently granted; etc.) to the class of user—e.g., different types, categories, etc. of users may complete different registration processes. Of interest and note in the diagram are the following entities:

MS 302 WD 306. For example, Mary's WD such as mobile telephone, BlackBerry, PalmPilot, etc.

MS 302 Personal Computer (PC) 308. For example, one of Mary's 302 home, work, etc. PCs.

WC 310. The provider of service for Mary's 302 WD 306.

MICV 120. As noted above the use of a MICV, although not required, provides significant advantages.

SP_{z} 210 Web Server (WS) 314. A publicly-available Web site that is optionally provided by SP_{z} 210.

SP_{z} 210 Billing Interface (BI) 316. A single, consolidated interface that SP_{z} 210 may use to easily reach, inter alia, one or more external entities such as a credit card or debit card clearinghouse, a carrier billing system, a service bureau that provides access to multiple carrier billing systems, a bank, etc.

SP_{z} 210 Application Server (AS) 318. A platform that facilitate aspects of the instant invention (and which will be described further below).

Bank 320. A visual placeholder for inter alia a financial institution, a clearinghouse, a service bureau, a credit card issuer, etc.

Merchant 322. A visual placeholder for inter alia a brick-and-mortar establishment, a vending machine, an on-line retailer, an appliance, a parking meter, etc.

It is important to note that while in FIG. 3 the MS 302 WD 306 and MS 302 PC 308 entities are illustrated as being adjacent or otherwise near each other, in actual practice the entities may, for example, be physically located anywhere.

In FIG. 3 the exchanges that are collected under the designation Set 1 represent the activities that might take place as Mary 302 initiates a registration process with SP_{z} 210 to inter alia create a new mWallet. Possibly inter alia:

A) Mary 302 uses one of her PCs 308 to visit SP_{z}'s 210 WS 314 to, possibly among other things, initiate a service registration process (see 324→326).

B) SP_{z}'s 210 WS 314 interacts with an AS of SP_{z} 210 (e.g., AS 318, see 328) to, possibly among other things, commit some or all of the information that Mary 302 provided to a repository (e.g., a database), optionally complete a billing transaction, etc.

The specific exchanges that were described above (as residing under the designation Set 1) are illustrative only and it will be readily apparent to one of ordinary skill in the relevant art that numerous other exchanges are easily possible and indeed are fully within the scope of the present invention. For example, the collected information may be reviewed, confirmed, etc. through one or more manual and/or automatic mechanisms.

In FIG. 3 the exchanges that are collected under the designation Set 2 represent the activities that might take place as SP_{z}'s 210 AS 318 sends for example a SMS message, comprising inter alia a Personal Identification Number (PIN), to Mary's 302 WD 306 (see 330→334).

The specific exchanges that were described above (as residing under the designation Set 2) are illustrative only and it will be readily apparent to one of ordinary skill in the relevant art that numerous other exchanges are easily possible and indeed are fully within the scope of the present invention. For example:

1) In the instant example the messages are shown traversing a MICV 120. As described previously, numerous alternatives are easily possible.

2) SP_{z} 210 may employ a Short Code (SC) or a regular Telephone Number (TN) as its source address (and to which it would ask users of its service to direct any reply messages). While the abbreviated length of a SC (e.g., five digits for a SC administered by Neustar under the Common Short Code (CSC) program) incrementally enhances the experience of a MS 302 (e.g., the MS 302 need remember and enter only a few digits as the destination address of a reply message) it also, by definition, constrains the universe of available SCs thereby causing each individual SC to be a limited or scarce resource and raising a number of SC/CSC management, etc. issues. A description of a common (i.e., universal) short code environment may be found in pending U.S. Pat. No. 8,019,362 titled “UNIVERSAL SHORT CODE ADMINISTRATION FACILITY” and its associated continuations.

3) A PIN may be generated internally by SP_{z} 210, secured by SP_{z} 210 from an external source, etc.

4) Any number of communication paradigms—such as inter alia MMS messaging, a voice call, Instant Messaging (IM), etc.—may be employed for aspects of the sequence 330→334.

5) Aspects of the sequence 330→334 may be repeated any number of times.

In FIG. 3 the exchanges that are collected under the designation Set 3 represent the activities that might take place as Mary 302 employs for example the PIN that she received on her WD 306 to continue the registration process (see 336→340) with possibly among other things an AS 318 of SP_{z} 120 (see 342) completing various processing activities.

The specific exchanges that were described above (as residing under the designation Set 3) are illustrative only and it will be readily apparent to one of ordinary skill in the relevant art that numerous other exchanges are easily possible and indeed are fully within the scope of the present invention. For example, aspects of the sequence 338→340 may be repeated any number of times.

In FIG. 3 the exchanges that are collected under the designation Set 4 represent the activities that might take place as an AS 318 of SP_{z} 120 dispatches to Mary 302 one or more confirmations. Such a confirmation may take the form of one or more E-Mail messages (see 344→346); one or more SMS, MMS, etc. messages (see 348→352); etc.

The specific exchanges that were described above (as residing under the designation Set 4) are illustrative only and it will be readily apparent to one of ordinary skill in the relevant art that numerous other exchanges are easily possible and indeed are fully within the scope of the present invention. For example, the sequence 344→346 and/or the sequence 348→352 may be repeated any number of times, Mary 302 may reply to one or more of the confirmations, etc.

The Set 1→Set 4 exchanges that were described above are illustrative only and it will be readily apparent to one of ordinary skill in the relevant art that numerous other exchanges are easily possible and indeed are fully within the scope of the present invention. For example and possibly inter alia:

1) A registration process, once initiated, may be completed through any combination of one or more channels including, inter alia, the World Wide Web (WWW, via for example a Web site that is operated by a SP), wireless messaging (such as SMS, MMS, etc.), E-Mail, IM, conventional mail, telephone, an Interactive Voice Response (IVR) facility, etc.

2) The registration information that was described above may subsequently be managed (e.g., existing information may be edited or removed, new information may be added, etc.) through any combination of one or more channels including, inter alia, a SP's WWW facility, wireless messaging (SMS, MMS, etc.), E-Mail, IM exchanges, conventional mail, telephone, an IVR facility, etc.

3) Information on the current physical location of Mary's 302 WD 306 (available through inter alia a Location-Based Service (LBS), a Global Positioning System (GPS), etc.) may be included during aspects of the registration process as inter alia an additional security, etc. measure.

4) During various of the activities that were described above a SP may communicate, interact, etc. (through for example an AS 318) with one or more external entities such as inter alia a Bank 320, a WC 310, etc. to among other things confirm, validate, etc. certain data; initiate, schedule, etc. different activities or processes; convey certain information; etc.

During the registration process that was described above a range of information may be captured from a MS including, inter alia:

A) Identifying Information. For example, possibly among other things, name, address, landline and wireless TNs, E-Mail addresses, IM names/identifiers, a unique identifier and a password, etc. Among other things, one or more identifying values (such as for example the TN of Mary's 302 WD 306) may be selected as the identifying value of Mary's 302 mWallet.

B) Financial Information. For example, credit card numbers, debit card numbers, pre-paid credit card numbers, pre-paid debit card numbers, stored value card numbers, bank details and bank account numbers, etc.

C) Billing Information. Different service billing models may be offered including, inter alia, none, a fixed one-time charge, a recurring (monthly, etc.) fixed charge, a recurring (monthly, etc.) variable charge, etc. Different payment mechanisms may be supported including, possibly among other things, credit or debit card information, authorization to place a charge on a MS's phone bill, etc.

D) Other Information. Additional, possibly optional, information. For example, a ‘whitelist’ of trusted merchants, a threshold under which payment requests may be automatically approved, etc.

The specific pieces of information that were described above are illustrative only and it will be readily apparent to one of ordinary skill in the relevant art that numerous other pieces of information (e.g., additional Financial Information, scheduled daily/weekly/etc. reporting desired and/or on-demand reporting desired, etc.) are easily possible and indeed are fully within the scope of the present invention.

As noted above the information that Mary provided during the registration process may be preserved in a data repository (e.g., a database). That information may optionally be organized as a MS Profile.

The content of Mary's profile may be augmented by a SP to include, as just a few examples of the many possibilities, internal and/or external demographic, psychographic, sociological, etc. data.

During various of the activities that were described above a SP's BI may optionally complete a billing transaction. The billing transaction may take any number of forms and may involve different external entities (e.g., a WC's billing system, a carrier billing system service bureau, a credit or debit card clearinghouse, etc.). The billing transaction may include, inter alia:

1) The appearance of a line item charge on the bill or statement that a MS receives from her WC. Exemplary mechanics and logistics associated with this approach are described in pending U.S. Pat. No. 7,640,211 titled “SYSTEM AND METHOD FOR BILLING AUGMENTATION” and its associated continuations. Other ways of completing or performing line item billing are easily implemented by those skilled in the art.

2) The charging of a credit card or the debiting of a debit card.

3) The generation of an invoice.

To continue with our hypothetical example . . . following completion of an optional registration process Mary may elect to add a quanta of value (including inter alia an amount of money, coupons, vouchers, credits, points, rewards/awards, etc.) to her mWallet.

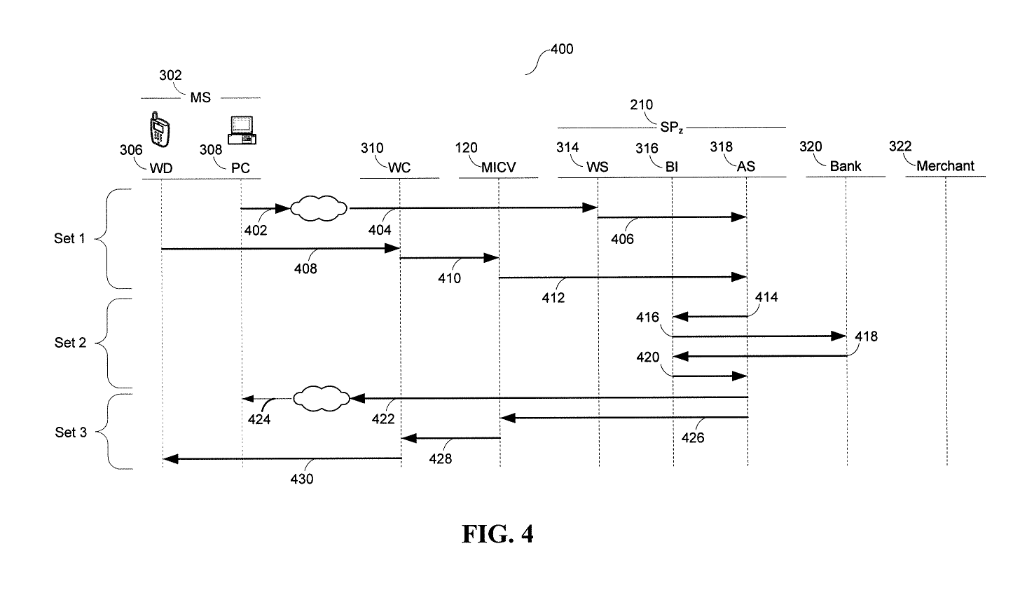

FIG. 4 and reference numeral 400 illustrate various of the exchanges or interactions that might occur during such a process. For consistency and simplicity FIG. 4 employs the same entities (MS 302, SP_{z} 210, MS 302 WD 306, etc.) as FIG. 3.

In FIG. 4 the exchanges that are collected under the designation Set 1 represent the activities that might take place as Mary 302 initiates the process of adding a quanta of value to her mWallet. Such an action may take place through inter alia Mary 302 using one of her PCs 308 to visit for example a Web site (see 402→406), Mary 302 using her WD 306 to inter alia dispatch one or more SMS messages (see 408→412), etc. For example and possibly inter alia:

1) The instant exchanges may comprise inter alia an indication of how the quanta of value is to be added, the amount of the quanta of value, an indication of the source(s) from which the quanta of value should be drawn, etc.

2) Mary 302 may be required to confirm (through inter alia a Web site, E-Mail, SMS, MMS, a voice call, etc.) the requested action.

The specific exchanges that were described above (as residing under the designation Set 1) are illustrative only and it will be readily apparent to one of ordinary skill in the relevant art that numerous other exchanges are easily possible and indeed are fully within the scope of the present invention. For example, a quanta of value may be added through any number of other channels including inter alia E-Mail, IM, a voice call, an IVR system, by postal mail, etc.

In FIG. 4 the exchanges that are collected under the designation Set 2 represent the activities that might take place as an AS 318 of SP_{z} 210 completes various processing activities including among other things interacting with a BI 316 (see 414→420), to optionally communicate/interact/etc. with for example a Bank 320, to inter alia add the requested quanta of value to Mary's 302 mWallet.

The specific exchanges that were described above (as residing under the designation Set 2) are illustrative only and it will be readily apparent to one of ordinary skill in the relevant art that numerous other exchanges are easily possible and indeed are fully within the scope of the present invention.

In FIG. 4 the exchanges that are collected under the designation Set 3 represent the activities that might take place as an AS 318 of SP_{z} 120 dispatches to Mary 302 one or more confirmations. Such a confirmation may take the form of one or more E-Mail messages (see 422→424); one or more SMS, MMS, etc. messages (see 426→430); etc.

The specific exchanges that were described above (as residing under the designation Set 4) are illustrative only and it will be readily apparent to one of ordinary skill in the relevant art that numerous other exchanges are easily possible and indeed are fully within the scope of the present invention. For example, the sequence 422→424 and/or 426→430 may be repeated any number of times, Mary may reply to one or more of the confirmations, etc.

The Set 1→Set 3 exchanges that were described above are illustrative only and it will be readily apparent to one of ordinary skill in the relevant art that numerous other exchanges are easily possible and indeed are fully within the scope of the present invention. For example and possibly inter alia:

1) The process that was described above may be optional. For example, during a registration process a MS may for example elect automatic approval, replenishment, etc.; may specify, schedule, identify, etc. the circumstances or the conditions for same; and among other things may tie or associate an aspect of their mWallet to inter alia:

A) Their WC account (so that when they use their mWallet the WC will approve/authorize the request and then for example charge the indicated amount to the MS' bill).

B) One of their bank accounts (so that when they use their mWallet the bank will approve/authorize and then for example deduct the indicated amount from an account, transfer the indicated amount from one account to another account, charge the indicated amount to an associated (e.g., overdraft, etc.) credit card, etc.).

2) Mary 302 may inquire as to the current status of her mWallet, remove a quanta of value from her mWallet, shift a quanta of value from one mWallet to another mWallet, etc.

As our hypothetical example advances . . . following the addition of a quanta of value to her mWallet Mary may elect to use her mWallet to for example complete the payment portion of a transaction.

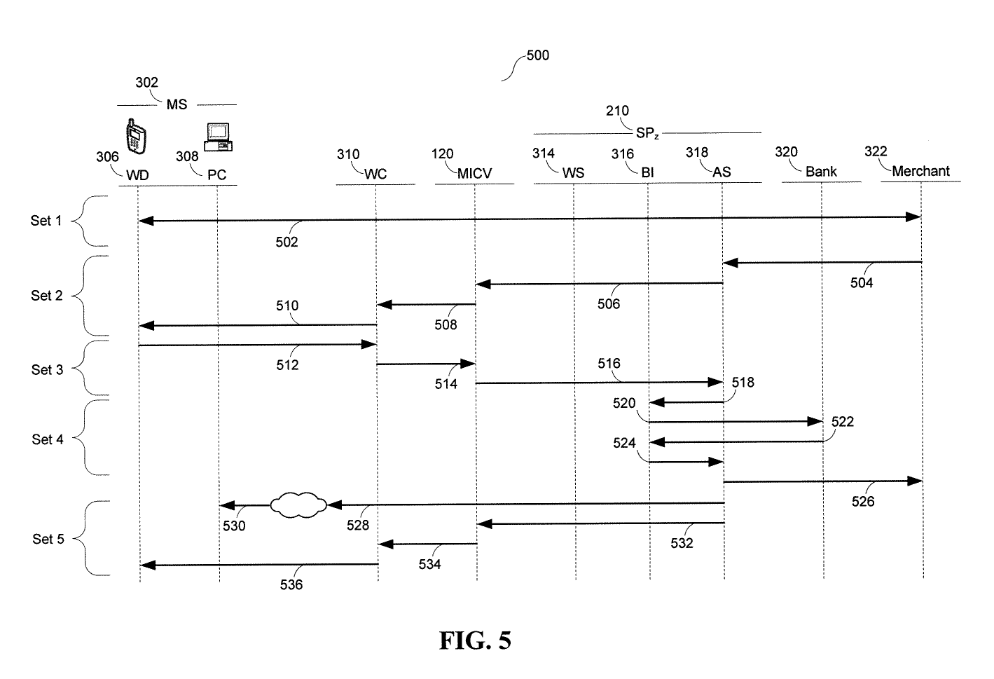

FIG. 5 and reference numeral 500 illustrate various of the exchanges or interactions that might occur during such a process. For consistency and simplicity FIG. 5 employs the same entities (MS 302, SP_{z} 210, MS 302 WD 306, etc.) as FIGS. 4 and 3.

In FIG. 5 the exchanges that are collected under the designation Set 1 represent the activities that might take place as Mary 302 for example conveys an identifier of her mWallet, such as inter alia the TN of her WD 306, to a Merchant 322 (see 502). Such a conveyance may take place through any number of channels or mechanisms including among other things Near Field Communication (NFC), bar codes, Bluetooth communication, verbal commands, Infrared (IR) communication, etc.

The specific exchanges that were described above (as residing under the designation Set 1) are illustrative only and it will be readily apparent to one of ordinary skill in the relevant art that numerous other exchanges are easily possible and indeed are fully within the scope of the present invention. For example, other information (beyond for example an identifier of an mWallet) may be conveyed.

In FIG. 5 the exchanges that are collected under the designation Set 2 represent the activities that might take place as the Merchant 322 interacts with possibly inter alia an AS 318 of SP_{z} 210 (see 504) to inter alia open a transaction. Among other things an AS 318 of SP_{z} 210 may dispatch an SMS message to Mary's 302 WD 306 (see 506→510) inter alia requesting that Mary 302 confirm the open transaction. Such a communication may comprise inter alia a date and time, a description of the transaction, identification of the merchant, the amount of the transaction, etc.

The specific exchanges that were described above (as residing under the designation Set 2) are illustrative only and it will be readily apparent to one of ordinary skill in the relevant art that numerous other exchanges are easily possible and indeed are fully within the scope of the present invention. For example, other communication paradigms (such as inter alia other forms of messaging (MMS, etc.), an IVR facility, a voice call, etc.) may be employed. Additionally, SP_{z} 210 may employ any number of values (such as for example a SC, a TN, etc.) as its source address (and to which it would ask users of its service to direct any reply messages).

In FIG. 5 the exchanges that are collected under the designation Set 3 represent the activities that might take place as Mary 302 replies (see 512→516) with possibly inter alia her PIN value.

The specific exchanges that were described above (as residing under the designation Set 3) are illustrative only and it will be readily apparent to one of ordinary skill in the relevant art that numerous other exchanges are easily possible and indeed are fully within the scope of the present invention. For example and possibly inter alia:

1) Mary 302 may need to reply within a specified amount of time for the reply to be considered valid.

2) Information on the current physical location of Mary's 302 WD 306 (available through inter alia a LBS, GPS, etc.) may be included during aspects of the confirmation as inter alia an additional security, etc. measure (e.g., is Mary 302, and thus her WD 306, actually at the Merchant 322).

In FIG. 5 the exchanges that are collected under the designation Set 4 represent the activities that might take place as an AS 318 of SP_{z} 210 completes various processing activities including possibly inter alia confirming the PIN value; interacting with one or more external entities (such as for example a Bank 320) via a BI 316 (see 518→524) to confirm, close, etc. the transaction; and dispatching an approval, notification, etc. to the Merchant 322 (see 526).

The specific exchanges that were described above (as residing under the designation Set 4) are illustrative only and it will be readily apparent to one of ordinary skill in the relevant art that numerous other exchanges are easily possible and indeed are fully within the scope of the present invention. For example:

1) Various of the indicated sequences may be repeated any number of times.

2) Additional challenges, confirmations, etc. may be introduced (depending on inter alia the amount of the transaction, etc.).

In FIG. 5 the exchanges that are collected under the designation Set 5 represent the activities that might take place as an AS 318 of SP_{z} 120 dispatches to Mary 302 one or more confirmations. Such a confirmation may take the form of one or more E-Mail messages (see 528→530); one or more SMS, MMS, etc. messages (see 532→536); etc.

The specific exchanges that were described above (as residing under the designation Set 5) are illustrative only and it will be readily apparent to one of ordinary skill in the relevant art that numerous other exchanges are easily possible and indeed are fully within the scope of the present invention. For example, the sequence 528→530 and/or 532→536 may be repeated any number of times, Mary may reply to one or more of the confirmations, etc.

The Set 1→Set 5 exchanges that were described above are illustrative only and it will be readily apparent to one of ordinary skill in the relevant art that numerous other exchanges are easily possible and indeed are fully within the scope of the present invention. For example, and possibly inter alia:

1) A SP may initiate, based perhaps on aspects of a MS Profile, additional confirmation, challenges, etc.—comprising among other things SMS, MMS, etc. messages; E-Mail; IM; a voice call; etc.—when inter alia a transaction amount exceeds a predefined threshold, the day/time of a transaction falls outside of a MS specified window, when a merchant location falls outside of a MS specified area, etc.

2) Various device-side security mechanisms (such as inter alia biometrics, etc.) may be employed by a MS on their WD.

The mWallet model that was described above may be extended, enhanced, etc. in any number of ways. For example and inter alia:

1) A MS may create several mWallets on their WD, assigning each mWallet a different identifying value.

2) A MS may indicate that certain types of payments (e.g., less than a certain amount, to a certain merchant, etc.) should be automatically processed by a SP without for example a request to a MS for their PIN value.

3) When the balance of an mWallet is exhausted, falls below a predefined threshold, etc. a SP may issue an alert—comprising among other things SMS, MMS, etc. messages; E-Mail messages; IM communication; a voice call; postal mail; etc.—based on possibly among other things entries in a MS Profile.

4) When the balance of an mWallet is exhausted, falls below a predefined threshold, etc. a SP may allow a MS to optionally refill their mWallet (a) automatically and/or (b) by inter alia visiting a Web site, through an (SMS, MMS, etc.) message exchange, by E-Mail, by IM, through a voice call, by postal mail, etc., based on possibly among other things entries in a MS Profile and with possibly among other things one or more confirmations.

5) An mWallet may also support inter alia loyalty cards (such as for example SAFEWAY™), membership cards (such as a sports club, COSTCO™, etc.), access cards (room or office, building, elevator, parking garage, etc.), etc.

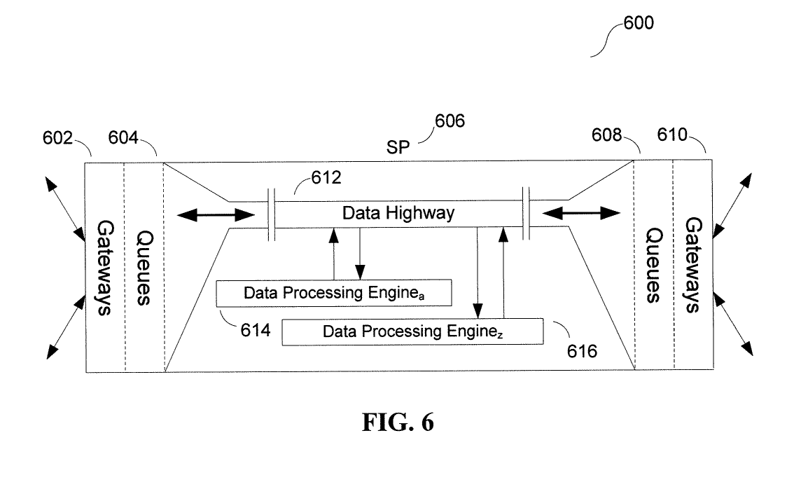

For purposes of illustration, FIG. 6 and reference numeral 600 depict a possible logical implementation of aspects of a SP 606 under one particular arrangement. The figure depicts among other things Gateways (602 and 610 that for example provide information/data receipt and dispatch capabilities, to/from different external entities, across possibly inter alia different application-level communication protocols), Queues (604 and 608 that for example provide interim storage and buffering capabilities), a Data Highway (DH 612, that for example provides interconnection capabilities), and DPEs 614→616.

A SP 606 may contain any number of other elements beyond those which are explicitly depicted in FIG. 6. For example, a SP may contain one or more repositories to support, inter alia, configuration, processing, monitoring, logging, reporting, etc. information. Such repositories may be implemented through any combination of conventional Relational Database Management Systems (RDBMSs), through Object Database Management Systems (ODBMSs), through in-memory Database Management Systems (DBMSs), or through any other equivalent facilities. Among other things, such repositories may be used to support:

1) Scheduled (e.g., daily, weekly, etc.) and/or on-demand reporting with report results delivered through SMS, MMS, etc. messages; through E-Mail; through a WWW-based facility; etc.

2) Scheduled and/or on-demand data mining initiatives (possibly leveraging or otherwise incorporating one or more external data sources) with the results of same presented through Geographic Information Systems (GISs), visualization, etc. facilities and delivered through SMS, MMS, etc. messages; through E-Mail; through a WWW-based facility; etc.

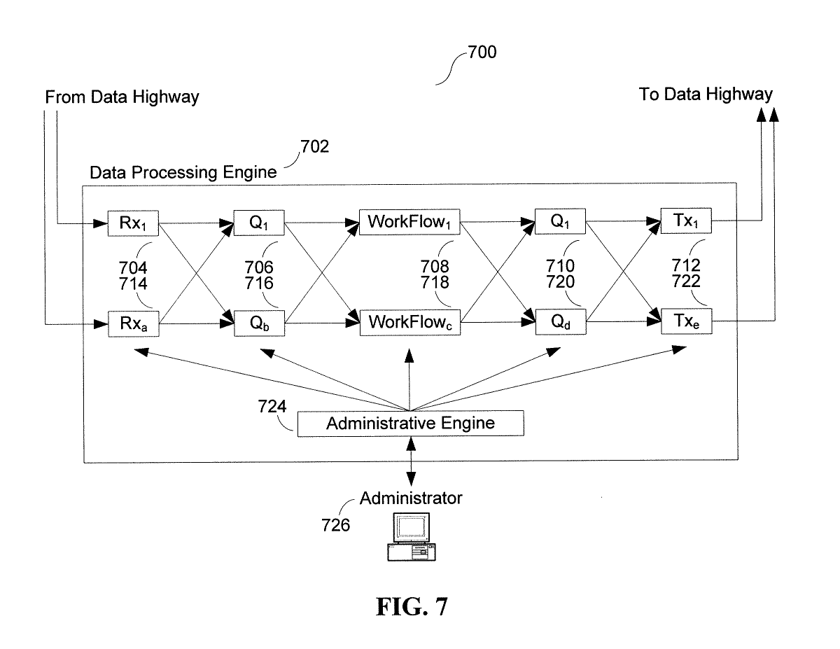

FIG. 7 and reference numeral 700 depict a possible logical implementation of aspects of a DPE 702. A DPE 702 may contain among other things several key components—Receivers (Rx₁ 704→Rxₐ 714 in the diagram), Queues (Q₁ 706→Q_{b} 716 and Q₁ 710→Q_{d} 720 in the diagram), WorkFlows (WorkFlow₁ 708→WorkFlow_{c} 718 in the diagram), Transmitters (Tx₁ 712→Txₑ 722 in the diagram), and an Administrator 726. It will be readily apparent to one of ordinary skill in the relevant art that numerous other components are possible within a DPE 702.

A dynamically updateable set of one or more Receivers (Rx₁ 704→Rxₐ 714 in the diagram) ‘get’ data from a SP DH and deposit same on an intermediate or temporary Queue (Q₁ 706→Q_{b} 716 in the diagram) for subsequent processing.

A dynamically updateable set of one or more Queues (Q₁ 706→Q_{b} 716 and Q₁ 710→Q_{d} 720 in the diagram) operate as intermediate or temporary buffers for incoming and outgoing data.

A dynamically updateable set of one or more WorkFlows (WorkFlow₁ 708→WorkFlow_{c} 718 in the diagram) remove incoming data from an intermediate or temporary Queue (Q₁ 706→Q_{b} 716 in the diagram), perform all of the required operations on the data, and deposit the processed data, results, etc. on an intermediate or temporary Queue (Q₁ 710→Q_{d} 720 in the diagram). The WorkFlow component may among other things implement various of the SP processing activities (such as inter alia supporting a MS registration and mWallet creation process, the addition of a quanta of value to an mWallet, inquiries as to the status of an mWallet, the use of an mWallet in connection with making a payment, etc.) that were described above.

A dynamically updateable set of one or more Transmitters (Tx₁ 712→Txₑ 722 in the diagram) remove processed data, results, etc. from an intermediate or temporary Queue (Q₁ 710→Q_{d} 720 in the diagram) and ‘put’ same on a SP DH.

An Administrative Engine 724 provides a linkage to all of the different components of a DPE 702 so that a DPE 702, along with all of the different components of a DPE 702, may be fully and completely administered or managed through, as just one example, a WWW-based interface. It will be readily apparent to one of ordinary skill in the relevant art that numerous other interfaces (e.g., a data feed, an Application Programming Interface (API), etc.) are easily possible.

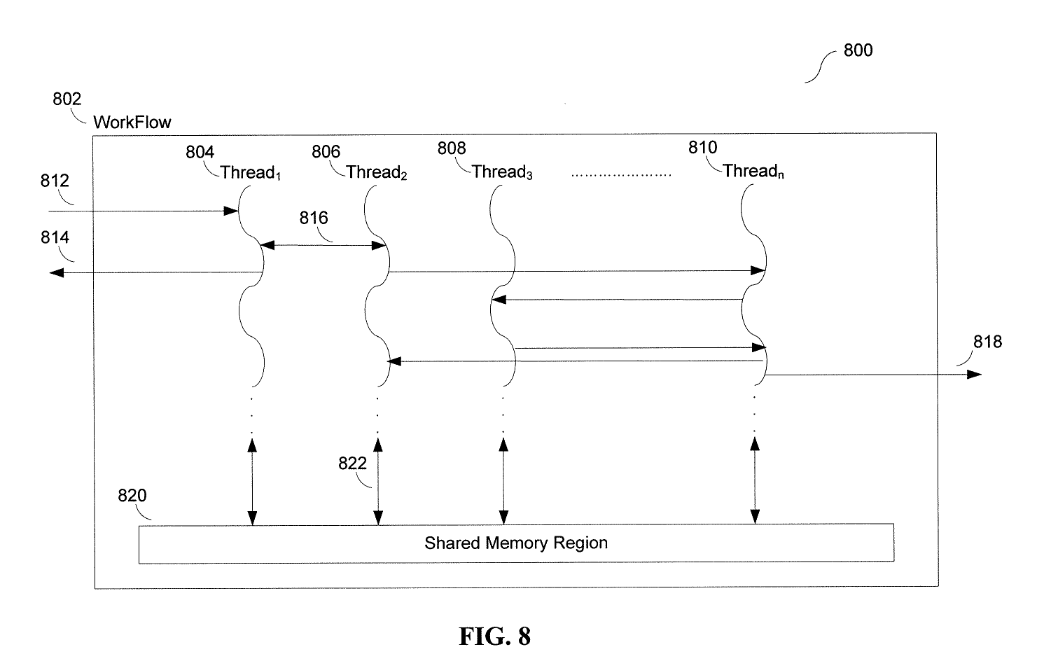

For purposes of illustration FIG. 8 and reference numeral 800 depict aspects of an exemplary WorkFlow environment 802 wherein possibly inter alia:

1) A dynamically adjustable number of threads (Thread₁ 804, Thread₂ 806, Thread₃ 808, . . . Threadₙ 810) may be inter alia created, started, allowed to operate or execute, quiesced, stopped, destroyed, etc. under control of for example the WorkFlow environment 802. Among other things one or more threads may for example realize, support, etc. aspects of one or more elements of a SP (such as described above) and/or a single thread may for example realize aspects of one or more elements of a SP (such as described above).

2) Different elements of a SP (such as described above) may communicate, interact, etc. with various of the threads (Thread₁ 804→Threadₙ 810) (see for example 812, 814, and 818).

3) Various of the threads (Thread₁ 804→Threadₙ 810) may among themselves communicate, interact, etc. (see for example 816).

4) Various of the threads (Thread₁ 804→Threadₙ 810) may communicate, interact, etc. with inter alia a Shared Memory Region (820) (see for example 822).

Various of the confirmation, request, etc. messages that were described above may optionally contain an informational element—e.g., a relevant or applicable factoid, etc. The informational element may be selected statically (e.g., all generated messages are injected with the same informational text), randomly (e.g., a generated message is injected with informational text that is randomly selected from a pool of available informational text), or location-based (i.e., a generated message is injected with informational text that is selected from a pool of available informational text based on the current pysical location of the recipient of the message as derived from, as one example, a LBS or GPS facility).

Various of the confirmation, request, etc. messages that were described above may optionally contain advertising—e.g., textual material if a simple paradigm (such as SMS) is being utilized, or multimedia (images of brand logos, sound, video snippets, etc.) material if a more capable paradigm (such as MMS) is being utilized. The advertising material may be selected statically (e.g., all generated messages are injected with the same advertising material), randomly (e.g., a generated message is injected with advertising material that is randomly selected from a pool of available material), or location-based (i.e., a generated message is injected with advertising material that is selected from a pool of available material based on the current physical location of the recipient of the message as derived from, as one example, a LBS or GPS facility).

Various of the confirmation, request, etc. messages that were described above may optionally contain promotional materials (e.g., still images, video clips, etc.).

The discussion that was presented above included TNs. However, it is to be understood that it would be readily apparent to one of ordinary skill in the relevant art that numerous other mWallet addresses or identifiers (such as possibly inter alia SCs, IP addresses, E-Mail addresses, IM handles, Session Initiation Protocol (SIP) addresses, etc.) are easily possible and indeed are fully within the scope of the present invention.

The discussion that was presented above referenced messaging generally and two specific messaging paradigms—SMS and MMS—specifically. However, as was noted previously, it will be readily apparent to one of ordinary skill in the relevant art that application of aspects of the present invention to numerous other communication paradigms (including inter alia a Voice over Internet Protocol (VoIP) data stream, software application data, a SIP-addressed artifact, a voice telephone call, an audio data stream, signaling and other command-and-control data, etc.) is easily possible and indeed is fully within the scope of the present invention.

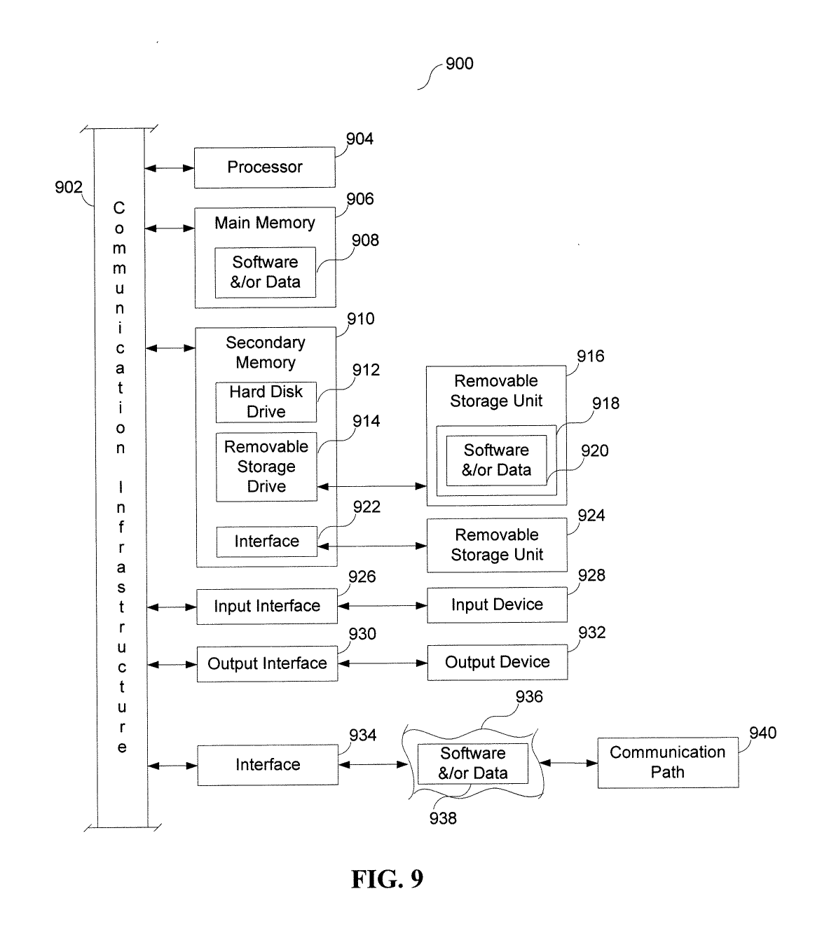

Various aspects of the present invention can be implemented by software, firmware, hardware, or any combination thereof. FIG. 9 illustrates an example computer system 900 in which the present invention, or portions thereof, (such as described above under paragraphs 27-147) can be implemented as computer-readable code. Various embodiments of the invention are described in terms of this example computer system 900. After reading this description, it will become apparent to a person skilled in the relevant art how to implement the invention using other computer systems and/or computer architectures.

Computer system 900 includes one or more processors, such as processor 904. Processor 904 can be a special purpose processor or a general purpose processor. Processor 904 is connected to a communication infrastructure 902 (for example, a bus or a network).

Computer system 900 also includes a main memory 906, preferably Random Access Memory (RAM), containing possibly inter alia computer software and/or data 908.

Computer system 900 may also include a secondary memory 910. Secondary memory 910 may include, for example, a hard disk drive 912, a removable storage drive 914, a memory stick, etc. A removable storage drive 914 may comprise a floppy disk drive, a magnetic tape drive, an optical disk drive, a flash memory, or the like. A removable storage drive 914 reads from and/or writes to a removable storage unit 916 in a well known manner. A removable storage unit 916 may comprise a floppy disk, magnetic tape, optical disk, etc. which is read by and written to by removable storage drive 914. As will be appreciated by persons skilled in the relevant art(s) removable storage unit 916 includes a computer usable storage medium 918 having stored therein possibly inter alia computer software and/or data 920.

In alternative implementations, secondary memory 910 may include other similar means for allowing computer programs or other instructions to be loaded into computer system 900. Such means may include, for example, a removable storage unit 924 and an interface 922. Examples of such means may include a program cartridge and cartridge interface (such as that found in video game devices), a removable memory chip (such as an Erasable Programmable Read-Only Memory (EPROM), or Programmable Read-Only Memory (PROM)) and associated socket, and other removable storage units 924 and interfaces 922 which allow software and data to be transferred from the removable storage unit 924 to computer system 900.

Computer system 900 may also include an input interface 926 and a range of input devices 928 such as, possibly inter alia, a keyboard, a mouse, etc.

Computer system 900 may also include an output interface 930 and a range of output devices 932 such as, possibly inter alia, a display, one or more speakers, etc.

Computer system 900 may also include a communications interface 934. Communications interface 934 allows software and/or data 938 to be transferred between computer system 900 and external devices. Communications interface 934 may include a modem, a network interface (such as an Ethernet card), a communications port, a Personal Computer Memory Card International Association (PCMCIA) slot and card, or the like. Software and/or data 938 transferred via communications interface 934 are in the form of signals 936 which may be electronic, electromagnetic, optical, or other signals capable of being received by communications interface 934. These signals 936 are provided to communications interface 934 via a communications path 940. Communications path 940 carries signals and may be implemented using wire or cable, fiber optics, a phone line, a cellular phone link, a Radio Frequency (RF) link or other communications channels.

As used in this document, the terms “computer program medium,” “computer usable medium,” and “computer readable medium” generally refer to media such as removable storage unit 916, removable storage unit 924, and a hard disk installed in hard disk drive 912. Signals carried over communications path 940 can also embody the logic described herein. Computer program medium and computer usable medium can also refer to memories, such as main memory 906 and secondary memory 910, which can be memory semiconductors (e.g. Dynamic Random Access Memory (DRAM) elements, etc.). These computer program products are means for providing software to computer system 900.

Computer programs (also called computer control logic) are stored in main memory 906 and/or secondary memory 910. Computer programs may also be received via communications interface 934. Such computer programs, when executed, enable computer system 900 to implement the present invention as discussed herein. In particular, the computer programs, when executed, enable processor 904 to implement the processes of aspects of the present invention, such as the steps discussed above under paragraphs 27-147. Accordingly, such computer programs represent controllers of the computer system 900. Where the invention is implemented using software, the software may be stored in a computer program product and loaded into computer system 900 using removable storage drive 914, interface 922, hard drive 912 or communications interface 934.

The invention is also directed to computer program products comprising software stored on any computer useable medium. Such software, when executed in one or more data processing devices, causes data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, Compact Disc Read-Only Memory (CD-ROM) disks, Zip disks, tapes, magnetic storage devices, optical storage devices, Microelectromechanical Systems (MEMS), nanotechnological storage device, etc.), and communication mediums (e.g., wired and wireless communications networks, local area networks, wide area networks, intranets, etc.).

It is important to note that the hypothetical examples that were presented above, which were described in the narrative and which were illustrated in the accompanying figures, are exemplary only. They are not intended to be exhaustive or to limit the invention to the specific forms disclosed. It will be readily apparent to one of ordinary skill in the relevant art that numerous alternatives to the presented examples are easily possible and, indeed, are fully within the scope of the present invention.

The following list defines acronyms as used in this disclosure.

| Acronym | Meaning |
|---|---|
| A2P | Application-to-Peer |
| API | Application Programming Interface |
| AS | Application Server |
| BI | Billing Interface |
| CD-ROM | Compact Disc Read-Only Memory |
| CP | Content Provider |
| CSC | Common Short Code |
| DBMS | Database Management System |
| DH | Data Highway |
| DPE | Data Processing Engine |
| DRAM | Dynamic Random Access Memory |
| E-Mail | Electronic Mail |
| EPROM | Erasable Programmable Read-Only Memory |
| GIS | Geographic Information System |
| GPS | Global Positioning System |
| IM | Instant Messaging |
| IR | Infrared |
| IVR | Interactive Voice Response |
| LBS | Location-Based Service |
| mBanking | Mobile Banking |
| mCommerce | Mobile Commerce |
| mWallet | Mobile Wallet |
| MEMS | Microelectromechanical Systems |
| MICV | Messaging Inter-Carrier Vendor |
| MMS | Multimedia Message Service |
| MS | Mobile Subscriber |
| NFC | Near Field Communication |
| ODBMS | Object Database Management System |
| P2P | Peer-to-Peer |
| PC | Personal Computer |
| PCMCIA | Personal Computer Memory Card International Association |
| PDA | Personal Digital Assistant |
| PIN | Personal Identification Number |
| PROM | Programmable Read-Only Memory |
| RAM | Random Access Memory |
| RDBMS | Relational Database Management System |
| RF | Radio Frequency |
| SC | Short Code |
| SIP | Session Initiation Protocol |
| SMS | Short Message Service |
| SP | Service Provider |
| 3P | Third Party |
| TN | Telephone Number |
| VoIP | Voice Over IP |
| WC | Wireless Carrier |
| WD | Wireless Device |
| WS | Web Server |
| WWW | World-Wide Web |

What is claimed is:

1. A method, performed on a computing device, that implements a Mobile Wallet (mWallet) facility for a plurality of users, the method comprising:
receiving a unique identifier that is associated with the mWallet facility;
ascertaining, using the unique identifier, information about the mWallet facility including at least a quanta of value that was previously added; and
sending aspects of the information to at least one of a merchant or a user.

2. The method of claim 1, wherein the unique identifier is a telephone number.

3. The method of claim 1, wherein the information comprises details defined by a user of the mWallet facility during a registration process.

4. The method of claim 3, wherein the details defined during the registration process includes one or more of Identifying Information, Financial Information, and Billing Information.

5. The method of claim 3, wherein the details defined during the registration process are preserved through a Mobile Subscriber (MS) Profile.

6. The method of claim 3, wherein the registration process is web-based.

7. The method of claim 3, wherein the registration process includes a billing component.

8. The method of claim 1, further comprising receiving a Personal Identification Number (PIN) from one of the users as part of a mobile commerce transaction.

9. The method of claim 8, wherein the PIN was provided to the one of the users during a prior registration process.

10. The method of claim 1, further comprising interacting with a financial institution to modify aspects of the mWallet facility.

11. The method of claim 1, wherein the quanta of value is based on a value of at least one of amount of money, coupons, vouchers, credits, points, rewards or awards.
